(19) United States
(12) Patent Application Publication
(10) Pub. No.: US 2026/0000023 A1
(43) Pub. Date: Jan. 1, 2026

(54) AGRICULTURAL WORKING MACHINE AND METHOD

(71) Applicant: CLAAS Selbstfahrende Erntemaschinen GmbH, Harsewinkel (DE)

(72) Inventors: Waldemar Thiesmann, Osnabrück (DE); Thomas Wagner, Steinhagen (DE)

(73) Assignee: CLAAS Selbstfahrende Erntemaschinen GmbH, Harsewinkel (DE)

(21) Appl. No.: 19/250,407

(22) Filed: Jun. 26, 2025

(30) Foreign Application Priority Data
Jun. 26, 2024 (DE) 10 2024 118 043.9

(51) Int. Cl. A01D 41/127; B60S 1/46; B60S 1/54; B60S 1/56

(52) U.S. Cl. CPC A01D 41/1278; A01D 41/1274; B60S 1/46; B60S 1/54; B60S 1/56; B60Y 2200/222

(57) ABSTRACT

An agricultural work machine and a method for operating an agricultural work machine. The agricultural work machine, which may comprise a combine harvester or forage harvester, may include a visualization device configured to display image data and process data, a monitoring device with a camera system for detecting fields of view in the surroundings of the agricultural work machine, a cleaning system to clean the camera system, and a data processing unit. The data processing unit is configured to generate context-relevant process data of the agricultural work machine and image data based on the detected fields of view. The cameras of the camera system may be attached to at least one support structure of the agricultural work machine and with fixed spatial assignment to one another.

### CROSS REFERENCE TO RELATED APPLICATION

This application claims priority under 35 U.S.C. § 119 to German Patent Application No. DE 10 2024 118 043.9 filed Jun. 26, 2024, the entire disclosure of which is hereby incorporated by reference herein.

### TECHNICAL FIELD

The present invention relates to an agricultural working machine a method for operating the agricultural working machine.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

An agricultural working machine (interchangeably termed an agricultural work machine) may include a camera system and a visualization device. The visualization device may display content or data to a machine operator, with the content visualized having been generated or detected at least indirectly by the camera system. This may enable the machine operator to have an extended field of vision, for example.

DE 10 2022 108 925 A1 and DE 10 2022 108 899 A1, each of which are incorporated by reference herein in their entirety, disclose mirror replacement systems with visualization devices and camera systems for agricultural work machines. US Patent Application Publication No. 2023/0286383 A1, incorporated by reference herein in its entirety, discloses an agricultural working machine with a camera system, a visualization system and a control device in communication with the visualization system, wherein the control device is configured to control the visualization system in such a way that information relevant to a selected work process is visualized.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates perspective views of an agricultural work machine in one aspect of the invention with different fields of view around the agricultural work machine.

FIG. 2 illustrate design variants of agricultural work machines.

FIG. 3 illustrate perspective views of an arm of an agricultural work machine.

FIG. 4 illustrate design variants of agricultural work machines.

### DETAILED DESCRIPTION

As discussed in the background, agricultural work machines may include a camera system and a visualization device. However, the camera system and/or the visualization device for the agricultural work machines may need improvement with regard to the clarity and information content of the displayed content.

In one or some embodiments, improved, such as detailed and yet clear, information is presented to a machine operator of an agricultural work machine. In particular, an improved agricultural work machine is disclosed in terms of efficiency and ergonomics, and an improved method of operation is disclosed as well.

In particular, in one or some embodiments, an agricultural work machine with a visualization device configured to display image data and process data is disclosed. The agricultural work machine may comprise a combine harvester or a forage harvester. The agricultural work machine may include a monitoring device with at least one camera system, such as a single camera system or a plurality of camera systems, for detecting field(s) of view in the surroundings of the agricultural work machine, a cleaning system configured to clean the camera system, and a data processing unit. The data processing unit may be configured to generate context-relevant process data of the agricultural work machine and image data based on the detected field(s) of view. In one or some embodiments, cameras of the camera system may be attached to at least one support structure of the agricultural work machine and with a fixed spatial assignment relative to each other.

For example, the agricultural work machine may be configured to perform one or more agricultural processes, such as a combine harvester or forage harvester, that includes any one, any combination, or all of a computer, a plurality of cameras, at least one display for displaying content, and a cleaning device for the cameras. The cameras may detect different parts or views of the surroundings of the device (e.g., a partial surrounding or a panoramic surrounding). In one or some embodiments, the computer may produce, calculate, or generate specific content based on the parts or views of the surroundings detected by the cameras. The specific content may comprise: image data that relates to image(s) indicative of one or more views or surroundings of the agricultural work machine; and process data that may relate to the context of use of the device, for example a quantitative or qualitative parameterization of the surroundings with regard to a harvest (e.g., data indicative of the agricultural process being perform by the agricultural work machine). The cameras may be arranged or attached to a part of the agricultural work machine in a fixed position in relation to each other, for example so that the part of the surroundings or the view detected by a respective camera may be geometrically fixed in relation to the part of the surroundings detected by another respective camera. The image data may then be output on the visualization device. In one specific embodiment, the image data may be concatenated (such as prior to clipping of the underlying image data) and then output on the visualization device in order to provide the surroundings of the agricultural work machine to the machine operator.

The disclosed agricultural work machine may enable the systematically detection and evaluation of the fields of view in such a way that the machine operator has both a good view of the fields of view and is provided relevant information about the agricultural process being performed by the agricultural work machine. In particular, the use of single or multiple cameras for both image data and for process data may be advantageous. In one or some embodiments, the image data and the process data may be provided while the number of cameras needed for this data may be reduced. The machine operator may have a view of the image data used for the process data, for example to check plausibility. The machine operator may thus receive valuable image and process information for a particular work task or a particular work method. It is therefore possible to use the monitoring device both to have a view of the surroundings, such as a mirror replacement system, as well as to support the execution or optimization of the work process. In one or some embodiments, the machine operator may have process data and image data displayed in an optimal selection, such as context-related.

Using the fixed position of the cameras in relation to each other, the susceptibility to errors may be reduced from the machine operator misinterpreting data or from an evaluation by the data processing unit being incorrect, for example because unintentional or unnoticed adjustment of cameras may be avoided. In addition, the necessary computing power or memory requirements for processing the signals emitted by the cameras may be reduced if the fields of view are fixed in relation to each other.

In one or some embodiments, it may also be ensured that the areas or fields of view detected by the cameras and the data generated therefrom are not falsified by soiling of the cameras because an automated and time-saving option for cleaning the cameras is disclosed.

In one or some embodiments, the agricultural work machine comprises an agricultural vehicle, such as a tractor or a harvester (e.g., a combine harvester or a forage harvester). The agricultural work machine may be designed self-propelled. The agricultural work machine typically may have a machine frame and, may have a vehicle cab fixed to the machine frame, such as resiliently and/or dampingly fixed thereto.

For example, the agricultural work machine may have one or more support structures. Support structures may comprise load-bearing and/or rigid parts of the agricultural work machine. The support structure may include, for example, any one, any combination, or all of: a vehicle cab; a cab roof; a cover part or an outer cover (e.g., a straw hood and/or a tailgate); a side flap; a transfer device for transferring harvested material; a chassis part or a chassis component; a drive axle; a rear axle and/or similar. Protective equipment may also comprise the support structure, for example, a railing and/or handrail.

In one or some embodiments, the monitoring device includes at least one camera system, such as a plurality of camera systems. In the case of a plurality of camera systems, each of the camera systems may have or may be formed by at least one camera, such as exactly one camera or a plurality of cameras. For example, a single camera system may have at least one (such as exactly one) camera or have a plurality of cameras. In one or some embodiments, a plurality of cameras are provided, whether as part of a single camera system with a plurality of cameras or by a plurality of camera systems with one or more cameras each. In one or some embodiments, the respective camera system may detect a respective field of view using a camera, or may detect a plurality of fields of view in the surroundings of the agricultural work machine using a plurality of cameras. In one or some embodiments, the area visually or optically detected by a camera or a camera system may comprise the field of view. A field of view is, for example, the area to which the particular camera system or an individual camera is directed. The surroundings of the agricultural work machine may refer to the area adjacent to the agricultural work machine or to the area in which the agricultural work machine is regularly located, for example an agriculturally used field, a road or an agricultural work area.

In one or some embodiments, the camera system may be understood as an arrangement of the one or more cameras. In one or some embodiments, the single camera system or the plurality of camera systems may be assigned to an individual support structure of the agricultural work machine. The fixed spatial assignment or arrangement of the cameras to one another may relate to the cameras on a single support structure and/or within a respective camera system. The fixed spatial assignment or arrangement of the cameras to each other may also refer to plurality of cameras and/or the plurality of camera systems across a plurality of support structures. The fixed spatial assignment may make it easier to merge or stitch together several fields of view in the image data in order to create a view of the surroundings.

A plurality of cameras or camera systems may be arranged basically symmetrically on the agricultural work machine in relation to the direction of travel of the agricultural work machine. For example, the cameras/camera systems may be arranged opposite each other transversely to the direction of travel. It may be understood that one or more or all of the cameras/camera systems are present or positioned in multiple ways, such as in opposite positions or in positions facing away from each other. Insofar as a specific camera system or a specific camera is referenced within the scope of the present disclosure, it is contemplated that a structurally identical camera system or a structurally identical camera is arranged on the opposite side of the agricultural work machine.

In one or some embodiments, the cleaning system may be s configured for automated cleaning. In one or some embodiments, the cleaning system may be activated by a cleaning command, for example from at least one processor (which may be resident in a computing device of the agricultural work machine, such as in the data processing unit and/or the monitoring system). The cleaning system may thus clean at least a part of the camera system. In one or some embodiments, a plurality of the cleaning systems may be provided, for example one respective cleaning system per a respective camera system. In one or some embodiments, the cleaning system may have one or more cleaning devices. Moreover, in one or some embodiments, a single cleaning device may be assigned to a single camera.

In one or some embodiments, the data processing unit is configured to generate data based on the detected fields of view. The data may also be understood as content to be displayed or displayable. In one or some embodiments, data may comprise the process data and/or the image data. In one or some embodiments, the data processing unit is configured to generate process data and image data, with each being based on the detected fields of view or, more specifically, based on data processing or data analysis of the detected fields of view.

In one or some embodiments, the process data is context-relevant in relation to the agricultural work machine, for example with regard to a work process currently being performed by the agricultural work machine, for example a “harvesting process” or “threshing”. The process data may relate to a particular context of use of the agricultural work machine. The process data may comprise objective information about the agricultural work machine or a work process, for example a crop flow, a fill level of a tank for harvested material (e.g., on a transport vehicle or on the agricultural work machine itself), or the like.

For example, it is contemplated that the machine operator may select a specific work process for the agricultural work machine, for example “threshing” for a combine harvester, wherein the process data is relevant for this specific work process that is selected. In one or some embodiments, a context of the particular work process may also be selected manually or automatically, for example a cutter bar in the case of “threshing”. In turn, the data processing unit may generate the process data for output on the visualization system (e.g., the process data that may be relevant for the particular work process, such as in relation to the particular context of performing the specific work process, may be visualized using the visualization system). This may, for example, concern a crop flow of harvested material in the cutting unit and/or corresponding data regarding the current throughput and the like. Other process data that may relate to the same work process but essentially relate to a different context, for example the operation of a threshing device and/or a separator, may not be visualized at all or may be visualized in a reduced form. In this way, because the process data of particular relevance is prioritized over other process data may make it easier for the machine driver to visualize the process data that is relevant for a current situation, depending on his/her interests and, if necessary, depending on what is needed. This may additionally simplify the operation of the agricultural work machine.

The image data may, for example, be visualizations of the surroundings, in a simple case camera image(s). For example, the image data may include image and/or video transmissions from the surroundings. The image data may relate to the surroundings of the agricultural work machine, such as in which way the agricultural work machine is moving or traveling. The image data may thus provide a visual view and/or contain a reproduction of the surroundings. The image data may alternatively or additionally, such as directly or indirectly, relate to a work process of the agricultural work machine, for example provide a view into components and/or working areas of the agricultural work machine, in particular obtain a view into a harvesting attachment, a threshing device, a separator, a cutting unit and/or the like. A video signal that may be received by the visualization device may provide the image data and/or the process data. For example, the process data may be readable and/or quantitative overlays in the image data (e.g., the data processing unit may determine which overlap to superimpose onto an image generated by the camera).

In one or some embodiments, the data generated by the data processing unit may be data or content to be displayed or at least displayable, for example a video signal that comprises image data and/or process data. The data processing unit may be configured to evaluate or analyze image(s) in order to generate the data for visualization. In one or some embodiments, the data processing unit may have a computer configured for data processing or may comprise a control unit. In one or some embodiments, the data processing unit may be in communication (e.g., wired and/or wirelessly) with the camera system or the cameras, for example, in order to receive data from them. It is contemplated that the camera system, the cameras and/or the data processing unit are connected to a bus system of the agricultural work machine. It is contemplated that the camera system or the cameras and the data processing unit are designed for wired and/or wireless communication with each other, such as at least unidirectional to the data processing unit, or bidirectional wired and/or wireless communication with the data processing unit.

In one or some embodiments, the cameras of the camera system or camera systems are attached to at least one support structure of the agricultural work machine. Two or more or all of the camera systems may also be attached with a fixed spatial assignment to each other. In particular, the particular cameras or camera systems point in directions that are arranged stationary or fixed in relation to each other. For example, one camera system or its camera(s) point(s) basically in the direction of travel, and another camera system or its camera(s) point(s) basically transverse to the direction of travel or opposite to the direction of travel. This advantageously enables the image data received from the particular camera systems or cameras to be in a fixed geometric relationship to one another, so that they may be processed with little computing effort and may also be understood quite intuitively by the machine operator.

The visualization device may be configured to display image data and/or process data. For example, a video transmission or a video signal, such as the image data, may be displayed by the camera system or by the cameras. The visualization device has, for example, one visualization unit or a plurality thereof. In one or some embodiments, the visualization device may have a control unit (that may include a processor and a memory) that is electrically connected to or in communication with some or all visualization units, for example to transmit data, such as one or both of the image data or process data, and/or to receive inputs and/or measured values, for example from the visualization unit or units. In one or some embodiments, the control unit may be in communication with the data processing unit and/or a work machine control unit in terms of data, for example in order to receive data from the data processing unit and/or a work machine control unit and/or to transmit data thereto. Alternatively, or additionally, the control unit may be part of the data processing unit and/or the work machine control unit (e.g., different processor threads being executed on the processor of the data processing unit in order to perform the functionality each of the visualization control unit and the data processing unit).

The visualization device, such as the visualization unit, may include a display, for example an LC display (LCD) or LED display (e.g., an OLED display), to display image data and/or process data. In one or some embodiments, the display may have backlighting so that it may also be read in the dark. In one or some embodiments, each visualization unit may have exactly one display, which may be, for example, basically square or rectangular in shape in the area that may display the content. Individual visualization units may also comprise (or consist of) a plurality of displays, for example by arranging the displays very close to each other. It is also contemplated that a plurality of displays of a visualization unit be positioned to have a predetermined distance between them. For example, a plurality of displays may be arranged or positioned on a support structure such as an A or B pillar, for example one above the other.

In one or some embodiments, the data processing unit is configured to generate numerical process data that serves to quantitatively detect a work process carried out in the context of use of the agricultural work machine. In one or some embodiments, the data processing unit may generate the process data by evaluating data or a signal from the camera system. The process data may include, for example, any one, any combination, or all of: a crop height of harvested material; in the case of grain as the harvested material, an ear count or a count of the ears (such as per unit area); or a density of the grain. It is also contemplated that the process data relates to lodged grain. Lodged grain is grain that has fallen over or been bent over. In this respect, the lodged grain may be localized and/or counted using the process data. It is further contemplated that the process data may indicate the flow of harvested material as a numerical value. For example, the process data may comprise information on whether anomalies occur or have been detected in the work process (e.g., the data processing unit, analyzing the data from the camera system(s), may detect the anomaly). Responsive to detecting the anomaly, the data processing unit may generate process data for visualization to notify the machine operator. For example, the process data may indicate an anomaly with regard to harvesting, such as refer to or provide corresponding information on whether soil or earth is being pushed up behind a harvesting attachment and/or a cutterbar. The data processing unit may generate numerical process data and visualize the process data in one or more ways (e.g., the numerical process data may be displayed as pure numerical value(s) and/or as graphical representations, for example as diagrams or the like.

In one or some embodiments, the data processing unit is configured to provide image data for the visualization device as a mirror replacement system, such as wherein the image data comprises sections, compilations and/or perspective-corrected representations of the fields of view. For example, a portion or section of a respective image (or respective video) may be displayed on a single display or across multiple displays of the visualization device. As another example, a compilation (which may comprise a stitching or a concatenation of part or all of images or videos generated by two respective cameras) may be generated, with the compilation being output on a single display or across multiple displays of the visualization device. In this respect, data or image data displayed using the visualization device may replace a physical rear-view mirror. The display may be performed with one or more front visualization units, for example on the A-pillar (e.g., a pillar on the cab of the agricultural work machine). In one particular example, different displays, which may be positioned in different parts of the driver's cab (such as pillars of the driver's cab), may have output thereon the respective views so that, to the machine operator, the views are seamless. For example, the data processing unit may only output a section of the respective image or video for an output on the display, which is positioned on a respective pillar, thereby mimicking the view that the machine operator would see absent the view being blocked by the respective pillar.

For example, a field of view located to the rear of the agricultural work machine in the direction of travel may be displayed in the field of vision of a machine operator, wherein the machine operator typically looks basically in the direction of travel. A lane image of the agricultural work machine may be displayed in order to anticipate the travel path, such as dynamically depending on a steering angle and/or statically. The lane image may refer to a hitching eye of the agricultural work machine. As one example, an eye monitoring system, such as disclosed in US Patent Publication No. 2023/0286383A1, incorporated by reference herein in its entirety, may be used to detect one or both of: a viewing direction of the operator indicative of a location of a visualization; or an object of the process information, which may be used for visualization. Further, the mirror replacement system may improve the visibility around the agricultural work machine in the manner of a wide-angle mirror. One, several or all physical mirrors may be dispensed with. The mirror replacement system may be designed in such a way that it meets the legal requirements for use in road traffic so that physical mirrors may be dispensed with. The legal requirements are known to the person skilled in the art or may be researched. In particular, in this regard, the mirror replacement system may be configured to provide a permanent view of the surroundings or be permanently available.

In one or some embodiments, the data processing unit is configured to provide image data which makes support structures, parts and/or sections of the agricultural work machine appear invisible, at least sectionally, when the image data is displayed in the field of view of a machine operator by means of the visualization device. In other words, for example, a video signal may be generated and displayed using the visualization device in such a way that the displayed video signal may make the visualization device or unit appear as a display window. In particular, the field of view on which the displayed image data is based may be advantageously located behind the particular visualization unit. This may create a larger field of vision for the machine operator, which may also increase safety because hazardous situations may be recognized more quickly. It is also possible to look upwards or downwards through support structures (e.g., support structures in the vehicle cab) which may be equipped with a visualization unit. For example, at least one camera system and/or at least one camera may be used to generate the image data that may be used for this purpose. The corresponding visualization unit may for example be arranged in the vehicle cab facing the machine operator, for example on the A-pillar.

In one or some embodiments, the data processing unit is configured for operation in different operating modes. The operating modes may include a road operating mode and a working operating mode. More than two operating modes may also be provided, for example a plurality of working operating modes that are individually context-related. In particular, one or more mirror replacement systems may be permanently provided or may be provided in the road operating mode. For example, image data may be displayed predominantly or at least almost exclusively in the road operating mode (e.g., the entire time that the agricultural work machine is in the road operating mode). For example, a physical and/or computer-implemented switch or button may be provided, which may be actuated by a user interaction by the machine operator in order to select an operating mode. For example, the mirror replacement system may be provided only optionally in work operating mode and permanently or compulsorily in road operating mode. It is possible that the agricultural work machine may be configured so that the road operating mode is switched on automatically depending on an operating surroundings and/or a location. As example, the road operating mode may be preselected upon each startup of the agricultural work machine so that it may be deselected manually as required. As another example, the agricultural work machine may include a GPS receiver, which may indicate a current location of the agricultural work machine. Responsive to the data processing unit determining, based on the current location and one or more maps stored locally or remotely, that the agricultural work machine is on a road, the data processing unit may automatically switch to road operating mode. Responsive to the data processing unit determining that the system is in road operating mode, the data processing unit may automatically visualize the image data, such as discussed above. In this regard, the road operating mode may increase safety, for example by improving the view of the machine operator of the surroundings. Ergonomics are also improved.

In one or some embodiments, the data processing unit is configured to provide image data that enables a view of the surroundings composed of at least two or more of the fields of view for a machine operator. For example, the mirror replacement system may also provide that at least two or more of the fields of view are combined. In one or some embodiments, the view of the surroundings may be provided by stitching together the fields of view of the camera system, a plurality of camera systems or plurality of cameras so that the a plurality of fields of view are depicted as a larger field of view in the image data. For example, it is contemplated for the image data to create a synthesis of fields of view that may overlap (or abut) and that together may cover a field of view width of more than 90°, such as more than 120°, more particularly more than 150°, in particular more than 170° or more than 180°. This may mean that a large environs may be detected and displayed as image data in a user-friendly or easy-to-understand manner. It is therefore possible to dispense with displaying a plurality of the fields of view separately from each other or to reproduce them on the visualization device.

In one or some embodiments, the data processing unit and/or the visualization device is configured to provide or to display process data and image data depending on a work process performed by the agricultural work machine, a user command, a switch position and/or a present operating mode of the data processing unit. In one or some embodiments, the data processing unit and/or the visualization device is configured to change and/or select the image data and/or the process data based on the user command and/or the switch position. In principle, it is envisioned that the data processing unit generates or selects the process data and the image data adaptively with respect to the work process or also with respect to any user commands or switch actuations. Alternatively or additionally, the visualization device may accordingly adaptively display, adjust and/or select the process data and/or image data. For example, depending on the work process, the ratio of process data to image data and/or their particular content may be adapted. In particular, work process A may have a first ratio of process data to image data, and work process B may have a second ratio of process data to image data that is different from the first ratio of process data to image data. Responsive to the data processing unit determining the specific work process, the data processing unit may control visualization of the process data/image data accordingly. The machine operator may influence or control the displayed process data and/or image data by individual selection. In particular, the machine operator may influence the displayed data, for example directly through the user command (which may dictate what process data and/or image data is visualized, and/or the ratio of process data to image data visualized) or the switch position and/or indirectly by the selection of a work process and, in particular, a related context.

In one or some embodiments, the agricultural work machine has an arm for attachment in an external mirror position of the agricultural work machine. In particular, at least one camera system or the camera system may be fixed to the arm. In one or some embodiments, one of a plurality of camera systems, for example a first camera system, may be partially or completely fixed to the arm (with the arm being attached at one end to at least a part of the agricultural work machine, such as an external portion of the agricultural work machine, and at an opposite end to at least one camera of the one or more camera systems). In one or some embodiments, the arm is at least substantially elongated. The arm may have a joint, for example to fold in the arm. In one or some embodiments, two of the arms may be provided, for example one arm on each side of the agricultural work machine, such as a left-sided and a right-sided arm. A camera system, such as the first camera system, may be provided for or positioned on each respective arm. The respective arm may partially or completely replace a particular exterior mirror in order to hold the particular camera system in the exterior mirror position instead of an exterior mirror or in addition to the exterior mirror. The exterior mirror position may be a position located to the side of the vehicle cabin relative to the direction of travel and/or exposed from the vehicle cabin. The respective arm may be configured to extend from the vehicle cabin. Starting from the arm, a camera system attached thereto may detect a large number of fields of view, for example in front of, next to and behind the agricultural work machine, and for example in the area around the front attachment. Thus, the arm may provide a good basis for the mirror replacement system or image data and, if necessary, process data.

The camera system, such as the first camera system, a second camera system and/or a third camera system, may comprise any one, any combination, or all of: a first camera; a second camera; a third camera; a fourth camera, etc. Other/further camera systems of the camera systems may be accordingly designed, for example comprising two or more cameras or a plurality thereof in each case.

The first camera, such as of the first camera system, may point basically against or opposite to the direction of travel. For example, the first camera may point or be directed in a substantially horizontal direction, which may be against the direction of travel. The first camera may be positioned or configured to detect a field of view that is substantially to the rear of the agricultural work machine in the direction of travel, such as for generating the image data and optionally the process data. The first camera may be used, for example, to provide the mirror replacement system. The first camera may, for example, provide a video transmission from the rear surroundings of the agricultural work machine. Context-relevant process data may also be generated based on the field of view of the first camera. In one or some embodiments, one or more cameras, which may generate image data as the first camera, may be provided. In one or some embodiments, one of the cameras may be designed as a telephoto exterior mirror camera, and another camera may be designed as a wide-angle exterior mirror camera. In this respect, the first camera may serve as one or both of a mirror replacement camera (e.g. a mirror replacement system-related camera) or a process camera (e.g., a work process-related camera).

The second camera, such as of the first camera system, may point or be positioned to point substantially towards the ground and/or be oriented substantially vertically. The second camera may thus be positioned and configured to detect a field of view located in a close range around the agricultural work machine and/or containing a harvesting attachment at least sectionally, and in particular for generating the image data and/or the process data. The field of view may be located in the immediate vicinity of the agricultural work machine. The field of view may include the harvesting attachment, for example in order to obtain a view in the direction of travel directly in front of or behind the harvesting attachment in order to generate image data and/or process data therefrom. In this respect, the second camera may serve as a process camera and/or as a mirror replacement camera.

The third camera, such s of the first camera system, may substantially point in the direction of travel and/or towards the ground. For example, the third camera may be positioned to point in a direction in the area between a horizontal direction and a vertical direction, such as at an angle. In particular, the third camera may be configured to detect a field of view located substantially at the front of the harvesting attachment in the direction of travel and containing the harvesting attachment at least partially, and in particular for generating the process data. In this respect, the third camera may comprise a process camera.

In one or some embodiments, at least one camera system, such as the first camera system, may be configured to pivot. In particular, various structures, such as the arm, may provide the camera system or its camera(s) with the ability to pivot. In particular, the first camera system may be configured, using the arm, to pivot about an axis, such as at least a substantially vertical pivot axis (e.g., within less than 10% of the vertical pivot axis; within less than 5% of the vertical pivot axis; within less than 2% of the vertical pivot axis; or within less than 1% of the vertical pivot axis). Accordingly, the camera or the cameras of the first camera system may be pivoted about the pivot axis by the arm.

In one or some embodiments, the arm for pivot-mounting one or more cameras, such as for the first camera system, may include a pivot part and a holding part. The holding part may be positioned on the side of the agricultural work machine or attached thereto. The pivot part may form a free end of the arm and/or be arranged facing away from the agricultural work machine. For example, the pivoting part may be pivotably fixed to the holding part, such as about the at least substantially vertical pivot axis (e.g., within less than 10% of the vertical pivot axis; within less than 5% of the vertical pivot axis; within less than 2% of the vertical pivot axis; or within less than 1% of the vertical pivot axis). The pivot part may be secured to the holding part about the pivot axis protected against overload. Overload protection may be formed, for example, by a structure, such as a spring-loaded cam assembly. In particular, the pivot part may be arranged fixed in relation to the holding part, but may overcome the overload protection and pivot in the event that too much force acts around the pivot axis. The pivot part may be fixed on the holding part to pivot by motor and/or to return by motor. For example, if the pivot part has been pivoted manually and has overcome or exceeded the overload protection, it may be reset by a motor. The motorized adjustment may also be used to change a detected field of view. In particular, the ability to pivot may prevent damage in the event of collisions, avoids collisions and simplifies loading of the agricultural work machine.

In one or some embodiments, the camera system, such as the first camera system, and the cleaning system may be at least partially installed in the pivot part. For example, the pivot part may have a frame for mounting cameras and/or the cleaning system or individual cleaning devices. In one or some embodiments, the pivot part may have a shield in front, such as in the direction of travel. The shield may provide mechanical protection in the event of collisions. The pivot part may have shading against sunlight for the first camera system. The shading may be formed by an adjustable screen, which may shade light incidence from basically above the horizon.

The camera system, such as the second camera system or another/further camera system, may be arranged or positioned on the cab roof and/or integrated therein, such as at least partially therein. The second camera system may be configured to detect a field of view located substantially at the front of the harvesting attachment in the direction of travel and/or at least sectionally containing the harvesting attachment. The field of view may be located in the immediate vicinity of the agricultural work machine. The field of view may include the harvesting attachment, for example, in order to obtain a view in the direction of travel directly in front of the harvesting attachment in order to generate image data and/or process data therefrom. The second camera system or its respective camera may serve as a process camera and/or as a mirror replacement camera.

In one or some embodiments, the second camera system may have two adjacent cameras. The optical axes of the two adjacent cameras may be arranged or positioned at an angle to each other and/or intersect, such as intersect along the direction of travel in front of the two adjacent cameras. This may mean that the two adjacent cameras are basically arranged opposite each other or facing each other and may be aligned with each other so that they look past each other. The fields of view and/or the optical axes may overlap, for example in a plan view of the agricultural work machine, such as around a center of the agricultural work machine. For example, a camera on the left-hand side in the direction of travel may point to the right, and a camera on the right-hand side in the direction of travel may point to the left so that the optical axes cross or intersect in front of the cameras in the direction of travel and may be at least in the plan view. This may create a more compact structure compared to previously known solutions. For example, the section of the agricultural work machine that contains the second camera system may be made more compact. This may be particularly advantageous in the cab roof with a limited amount of space.

The camera system, such as the third camera system or another/further camera system, may be positioned on the support structure or another/further support structure or arranged thereon, for example on any one, any combination, or all of: the vehicle cab; the cab roof; the cover part; the straw hood; or the side flap. The third camera system may be configured to detect a further field of view, such as to generate image data containing a bird's eye view (e.g., a view from directly above). The third camera system may thus be arranged on various support structures in order to provide a further basis for image data or process data as well. The third camera system may be primarily intended as a mirror replacement camera, and optionally as a process camera. For example, using the third camera system, a field of view with a view to the side of the agricultural work machine and/or behind the agricultural work machine may be generated.

The camera system, such as the third camera system or another/further camera system, may have two cameras arranged opposite each other. The two cameras may be arranged or positioned facing in directions that are substantially opposite to each other. For example, mirror-symmetrical fields of view in relation to a center of the agricultural work machine may be thereby covered. In particular, one of the cameras may be located on the left-hand side of the agricultural work machine, and the other camera may be located on the right-hand side of the agricultural work machine.

The camera system, such as the fourth camera system or another/further camera system, may be arranged or positioned on the support structure or a further/other support structure or may be arranged thereon, for example on the transfer device, such as on a free end of the transfer device (e.g., a chute). In particular, the fourth camera system may generate a field of view for detecting a target area of harvested material to be transferred. The fourth camera system may generate a perspective view that emanates from the transfer device in order to provide a further basis for image data or also process data. For example, using the fourth camera system, a field of view may be generated with a view of a target area that is to be hit by the harvested material to be transferred.

The camera system, such as the fifth camera system or another/further camera system, may be arranged on the support structure or a further/other support structure, for example on an axle of the agricultural work machine, such as between the harvesting attachment and the rear axle or drive axle and/or on the rear axle or drive axle. In particular, the fifth camera system may be configured to detect a field of view located between an axle or the rear axle and the harvesting attachment and/or containing the harvesting attachment at least sectionally. For example, starting from the rear axle, a relevant view may be obtained of the area to the rear of the harvesting attachment in the direction of travel. In this respect, the field of view may point in the direction of travel towards the harvesting attachment and contain its rear and the ground. For example, the fifth camera system may be located or positioned on the underside of the agricultural work machine. Thus, a perspective may be provided that enables generated process data or image data that may facilitate the operation of the agricultural work machine, for example by reducing downtimes through faster fault detection.

In one or some embodiments, the cleaning system may, for example, clean using a contacting and/or a non-contacting principle of action. For example, the cleaning system, such as a part of the cleaning device, may have a nozzle, for example a washing nozzle and/or compressed air nozzle. The cleaning device or nozzle may be arranged or positioned facing one or more of the cameras and/or one or more of the camera systems. The cleaning system may be configured to operate with compressed air and/or liquid. In one or some embodiments, the cleaning system has a nozzle or several nozzles for ejecting compressed air and/or liquid, such as onto the camera system or onto at least one of the camera systems and/or onto at least one of the cameras. An inclination of the nozzle, such as relative to the particular camera system or to the particular camera, may be adjustable, for example via motorized adjustment (e.g., using a motor) and/or command-controlled adjustment (e.g., the data processing unit may issue a command in order to control the motor to adjust the inclination of the nozzle). In the case of a plurality of nozzles, a respective nozzle may be provided in order to clean each camera and/or each camera system. Each camera system or each camera may thus be assigned its own cleaning system or its own cleaning device or nozzle.

A method for operating an agricultural work machine or the agricultural work machine is also disclosed. In particular, the method provides that:
the agricultural work machine performs a work process, with the camera system detecting one or more fields of view, such as by using camera(s) arranged in a fixed position relative to one another;
context-relevant process data of the agricultural work machine and image data of an environs of the agricultural work machine are generated based on the detected fields of view; and
the process data and the image data are displayed, such as using a visualization unit or visualization device of the agricultural work machine.

In the context of the disclosure, the abbreviation “or” is short for “or respectively” and is intended to indicate alternative, basically equivalent and/or synonymous features or terms in order to convey the idea or meaning of a feature or term usage. “Or respectively” may always be replaced by “and/or”.

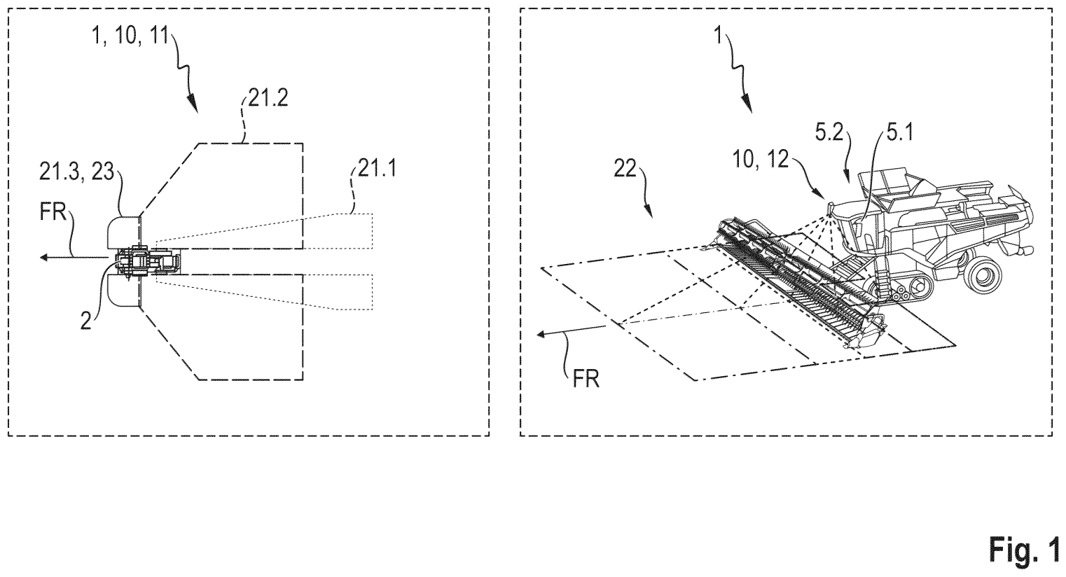

Referring to the figures, FIG. 1 on the left illustrates an agricultural work machine 1 with a visualization device 3 configured to display data, such as image data and/or process data. Example operations of the agricultural work machine 1 are described in US Patent Application Publication No. 2014/0019017 A1, incorporated by reference herein in its entirety. The agricultural work machine 1 may travel in a direction of travel FR for harvesting, for example. The visualization device 3 may display the data to a machine operator. The agricultural work machine 1 may have a monitoring device 10 with a plurality of camera systems 11, which may be configured to detect fields of view 21.1, 21.2, 21.3, 23 in the surroundings of the agricultural work machine 1. Thus, the plurality of camera systems 11 may be configured to detect any one, any combination, or all of the fields of view 21.1, 21.2, 21.3, 23. Furthermore, a cleaning system, configured to clean the camera systems 11, and a data processing unit 20 may also be provided.

In one or some embodiments, the data processing unit 20 may comprise at least one processor 26, at least one memory 27 (configured to store data, such as image data and/or context-relevant process data and/or computer-executable instructions stored on the tangible memory), and at least one communication interface 28 (configured to communication with devices external to the data processing unit 20). The at least one processor 26 and at least one memory 27 may be in communication (e.g., wired and/or wirelessly) with one another. In one or some embodiments, the processor 26 may comprise a microprocessor, controller, PLA, or the like. Similarly, the memory 27 may comprise any type of storage device (e.g., any type of memory, such as RAM, ROM, or a combination thereof). Though the processor 26 and the memory 27 are depicted as separate elements, they may be part of a single machine, which includes a microprocessor (or other type of controller) and a memory. Alternatively, the processor 26 may rely on the memory 27 for all of its memory needs. Still alternatively, the processor 26 may rely on a database for some or all of its memory needs. The memory 27 may comprise a tangible computer-readable medium that include software that, when executed by the processor 26 is configured to perform any one, any combination, or all of the functionality described herein. Further, the communication interface 28 may be configured to communicate (e.g., wired and/or wirelessly) with one or more electronic devices.

The processor 26 and the memory 27 are merely one example of a computational configuration for the electronic devices discussed herein. Other types of computational configurations are contemplated. For example, all or parts of the implementations may be circuitry that includes a type of processor, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

In one or some embodiments, monitoring device 10 includes at least one processor 26, at least one memory 27, and at least one communication interface 28 (such as illustrated for data processing unit). Alternatively, the at least one processor 26, the at least one memory 27, and the at least one communication interface 28 of the data processing unit 20. Further, commands may be generated to control the plurality of camera systems 11, 12, 13, 14, 15 (e.g., to control the mechanical position of the cameras, such as by controlling motor 29 to pivot at least one camera; to control electronic operations of the plurality of camera systems 11, 12, 13, 14, 15) may be generated by the at least one processor 26 (whether the processor is resident within monitoring device 10 and/or within data processing unit 20). Alternatively, or in addition, the at least one processor 26 may generate command(s) to control respective cleaning systems 18, as discussed further below.

In one or some embodiments, the data processing unit 20 may generate context-relevant process data and image data based on the detected fields of view 21.1, 21.2, 21.3, 23. The camera systems 11 or their respective cameras may have a fixed spatial assignment to each other and may be attached to support structures of the agricultural work machine 1. In one or some embodiments, both the process data and the image data may be generated using the camera systems 11 for display to the machine operator substantially in real time.

In one or some embodiments, the fields of view 21.1, 21.2, 21.3, 23 may be arranged at least substantially symmetrically to the right and left of the agricultural work machine 1 in the direction of travel FR. In one or some embodiments, the fields of view 21.1, 21.2, 21.3, 23 are fixed and non-changeable. Alternatively, or in addition, the fields of view 21.1, 21.2, 21.3, 23 may be controllable or configurable, such as by controlling (via one or more commands) so that the fields of view 21.1, 21.2, 21.3, 23 are in predetermined positions. As discussed above, the at least one processor 26 may send one or more commands (e.g., commands to motor(s) 29) to position one or more respective cameras 11.1, 11.2, 11.3, 12.1, 12.2 in a predetermined position (e.g., by moving pivoting part 16.2) so that any one, any combination, or all of the fields of view 21.1, 21.2, 21.3, 23 are in predetermined positions.

The field of view designated by reference sign 21.1 is located substantially to the rear of the agricultural work machine 1 in the direction of travel FR. This field of view 21.1 may substantially represent a field of vision of a main exterior rear-view mirror.

The field of view designated by reference sign 21.2 is located in the proximity of the agricultural work machine 1 and may contain a harvesting attachment 2 of the agricultural work machine 1, at least sectionally. This field of view 21.2 may be basically arranged next to and behind the agricultural work machine 1 and may form a field of view of a wide-angle exterior mirror.

The field of view designated by reference sign 21.3 is located substantially at the front of the harvesting attachment 2 in the direction of travel FR and includes it at least sectionally. This field of view 21.3 may basically be arranged next to and in front of the agricultural work machine and may form a field of view of a close-range or approach mirror.

FIG. 1 on the right illustrates the agricultural work machine 1 in the form of a combine harvester. The agricultural work machine 1 has a harvesting attachment 2, which may be arranged or positioned at the front of the agricultural work machine 1 in the direction of travel FR. The agricultural work machine 1 may further include a monitoring device 10, which may comprise a second camera system 12 with one or more cameras, such as two cameras for detecting fields of view 22 in the surroundings of the agricultural work machine 1. The cameras of the second camera system 12 may be attached to or integrated into a cab roof 5.2 with a fixed spatial assignment to each other. The data processing unit 20 may be configured to generate context-relevant process data and image data based on the detected fields of view 22. The fields of view 22 may be located substantially at the front of the harvesting attachment 2 in the direction of travel FR and may contain the harvesting attachment 2 at least sectionally. In one or some embodiments, the agricultural work machine 1 may have visualization device 3 in a vehicle cab 5.1 provided with the cab roof 5.2, which may display the process data and the image data to a machine operator. Various types of visualization devices 3 are contemplated, such as an LCD display, LED display or the like. For example, the visualization device 3 may have visualization units in the form of displays.

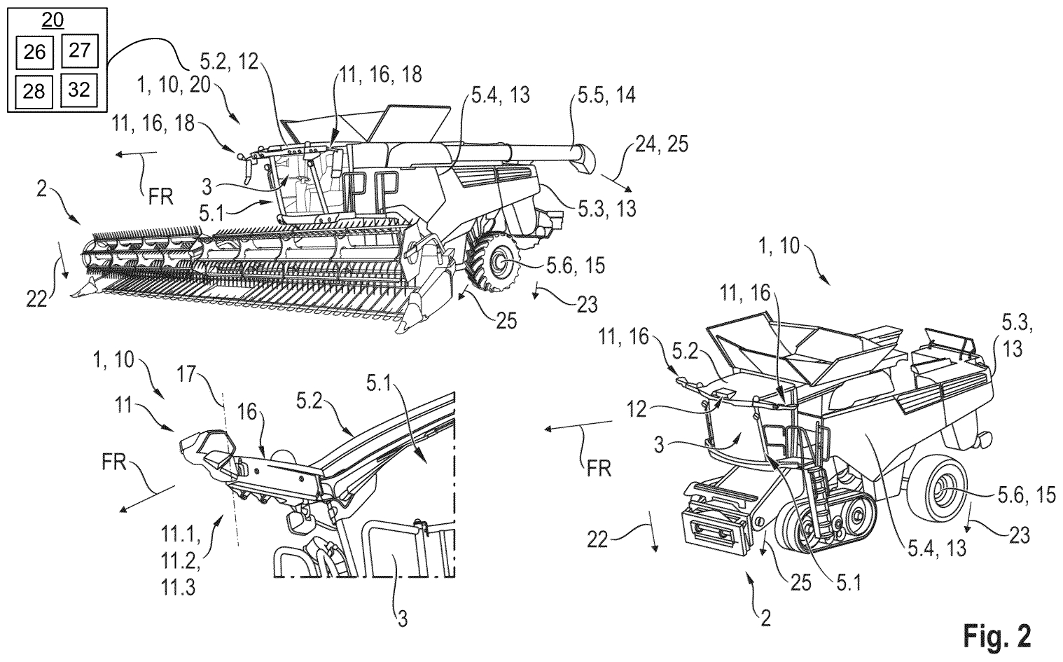

FIG. 2 at the top left illustrates an agricultural work machine 1, which is designed as a combine harvester. The harvesting attachment 2 configured to harvest is provided at the front in the direction of travel FR. The agricultural work machine 1 may further include a vehicle cab 5.1, in which a visualization device 3 with a plurality of displays is provided for displaying image data and process data. The agricultural work machine 1 may also have a monitoring device 10 with a plurality of camera systems, such as five camera systems 11, 12, 13, 14, 15 for detecting respective fields of view 21, 22, 23, 24, 25 in the surroundings of the agricultural work machine 1. Cleaning systems 18 for cleaning the camera systems 11, 12, 13, 14, 15 and the data processing unit 20 may also be provided. The data processing unit 20 is configured to generate context-relevant process data and image data in each case on the basis of the detected fields of view 21, 22, 23, 24, 25, wherein respective cameras of the camera system 11, 12, 13, 14, 15 may be attached to respective support structures 5 of the agricultural work machine 1 and with fixed spatial assignment to one another.

The data processing unit 20 may be configured to generate numerical process data. The numerical process data may serve to quantitatively detect a work process being performed in the context of use of the agricultural work machine 1. In this way, a machine operator may recognize anomalies during harvesting, for example the location and/or quantity of lodged grain or the like.

Furthermore, one or more arms, such as two arms 16, may be provided, on each of which at least a part of the first camera system 11 (e.g., cameras of the first camera system 11) may be arranged. A mirror replacement system may be provided using at least one of the camera systems, such as the first camera system 11. In particular, the data processing unit 20 may be configured to provide image data for the visualization device 3, with the image data output on the visualization device 3 effectively acting as the mirror replacement system. The image data may contain any one, any combination, or all of sections, compilations or perspective-corrected representations of any one, any combination, or all of the fields of view 21, 22, 23, 24, or 25. In this way, an ergonomically favorable view of the surroundings is provided to a machine operator. Further, in one or some embodiments, input (e.g., via the touchscreen 32) may be used to configure which of the one, the combination, or all of the sections, compilations or perspective-corrected representations and/or which of the one, the combination, or all of the fields of view 21, 22, 23, 24, or 25.

In one or some embodiments, the data processing unit 20 may be operated in various operating modes, such as in a road operating mode and/or a work operating mode. For example, responsive to the data processing unit 20 determining that the mode is the road operating mode (e.g., responsive to input from the machine operator), the data processing unit 20 may control the visualization device 3 to operate as the mirror replacement system. Alternatively, or in addition, responsive to the data processing unit 20 determining that the mode is the work operating mode, the data processing unit 20 may control the visualization device 3 to operate as the mirror replacement system. Furthermore, the data processing unit 20 may output image data on the visualization device 3 in which view(s) of the surroundings composed of a plurality of the fields of view 21, 22, 23, 24, 25 may be output for the machine operator. Merely as one example, rear-view mirrors and/or exterior mirrors may be replaced by the view of the surroundings that is output on the visualization device 3. In this way, the physical mirrors may effectively be replaced with electronic mirrors (via the visualization device 3).

In one or some embodiments, the data processing unit 20 may provide process data and/or image data depending on any one, any combination, or all of: an executed work process of the agricultural work machine 1; on a user command; or on a switch position. As one example, a specific work process of the agricultural work machine 1 may be programmed into the processor 26 (e.g., in data processing unit 20). Responsive to the data processing unit 20 determining the specific work process, the data processing unit 20 may access in the memory 27 a table of process data and/or image data correlated to different specific work processes. Using the specific work process programmed, the data processing unit 20 may access the specific process data and/or the specific image data to be output on the visualization device 3 that is tailored to the specific work process. Alternatively, the data processing unit 20 may receiving a user command (e.g., via the touchscreen 32; via a mechanical switch; or via a virtual switch on the touchscreen 32). In this way, the data processing unit 20 may change and/or select the image data and the process data For example, the data processing unit 20 may select a subset of the image data (e.g., clip a subpart of an image or a video) for visualization and/or may modify the image data (e.g., place an overlay to emphasize one or more aspects of the image data) for visualization

In one or some embodiments, the first camera system 11 comprises a plurality of cameras. The first camera system 11 may be configured using the arms 16 to pivot about an at least substantially vertical pivot axis. For example, the arm may be folded in to protect at least the first camera system 11 from or in collisions. As discussed above, the pivoting of the arms may be controlled by the at least one processor 26.

In one or some embodiments, the second camera system 12 comprises two adjacent cameras and may be arranged on or integrated into a cab roof 5.2 and may configure the field of view 22 located substantially at the front of the harvesting attachment 2 in the direction of travel FR and containing the harvesting attachment 2.

In one or some embodiments, the third camera system 13 has plurality of cameras, such as opposite each other on two sides of the agricultural work machine 1, and may be arranged on a support structure 5 designed as a side flap 5.4 or cover part. The third camera system 13 may serve to detect a field of view 23 to generate image data containing a view from above or a bird's eye view.

In one or some embodiments, the fourth camera system 14 has at least one camera and may be arranged or positioned on a support structure 5 designed as a transfer device 5.5. An example of the transfer device 5.5 comprises a discharge chute. See US Patent Application Publication No. 2024/0237580 A1, incorporated by reference herein in its entirety. The fourth camera system 14 may detect a target area of the harvested material to be transferred as the field of view 24.

In one or some embodiments, the fifth camera system 15 has plurality of cameras and may be arranged or positioned between the harvesting attachment 2 and the rear axle or drive axle 5.6. The fifth camera system 15 may detect the field of view 25 containing the harvesting attachment 2.

The data processing unit 20 may be configured to provide image data which enables support structures, parts and/or sections of the agricultural work machine 1 to appear invisible (e.g., at least electronically on the visualization 3), at least sectionally, when the image data is displayed in the field of view of a machine operator using the visualization device 3. For example, the visualization device 3 or its displays for this purpose may be arranged in various parts of the vehicle cab 5.1, such as on the A-pillar for this purpose, wherein the A-pillar may represent a support structure of the agricultural work machine 1.

FIG. 2, bottom left, illustrates a section of an agricultural work machine 1. Depicted is an arm 16 arranged on the left side of a vehicle cab 5.1 in the direction of travel FR, such as on the cab roof 5.2 thereof, with the first camera system 11 of a monitoring device 10. The first camera system 11 may be pivoted on a pivoting part of the arm 16 about a substantially vertical pivot axis 17. The first camera system 11 may have one or more cameras, such as at least a first camera 11.1, at least a second camera 11.2 and at least a third camera 11.3, each of which may address different fields of view. The fields of view are, for example, one or more fields of view as shown in FIG. 1 on the left, which are referenced there as 21.1, 21.2, 21.3 or 23.

With further reference to FIG. 2, bottom left, visualization device 3 is illustrated in the vehicle cab 5.1. In one or some embodiments, the visualization device 3 may display context-relevant process data and image data generated by data processing unit 20 (e.g., a computer or a control unit which may include at least one processor 26, at least one memory 27, and at least one communication interface 28), based on data generated by and received from the camera system 11 or visualize them for a machine operator. In one or some embodiments, the arm 16 does not have an external mirror or reflective element. Rather, outputting the data on visualization device 3 may result in physical mirrors being dispensed with.

FIG. 2 on the right illustrates an agricultural work machine 1, for example in the form of a combine harvester. A harvesting attachment 2, which may be arranged or positioned at the front in the direction of travel FR, is shown as partially hidden. Visualization device 3 with one or more displays may be positioned in or on vehicle cab 5.1 and may be configured to display image data and process data. As discussed above, the agricultural work machine 1 may include a monitoring device 10 (with camera systems 11, 12, 13, 15 configured to detect fields of view 22, 23, 25 in the surroundings of the agricultural work machine 1), cleaning systems for cleaning the camera systems 11, 12, 13, 15 and a data processing unit 20. The data processing unit 20 may be configured to generate context-relevant process data of the agricultural work machine 1 and image data based on the detected fields of view 22, 23, 25. One, some, or all cameras of the camera systems 11, 12, 13, 15 may be attached to support structures 5 of the agricultural work machine 1 with a fixed spatial assignment or relation to each other, such as a respective camera may have the fixed spatial assignment or relation to one, some, or each of the remaining cameras of the camera systems 11, 12, 13, 15.

In the embodiment illustrated on the right in FIG. 2, at least a part of a first camera system 11, such as the cameras of the first camera system 11, may be arranged or positioned on two pivoting arms 16. The second camera system 12 may be integrated into a cab roof 5.2 in order to detect the field of view 22 with two cameras. The third camera system 13 may be arranged or positioned on an outer cover 5.3 (e.g., in the form of a straw hood) and on a side flap 5.4 and may be configured to detect the field of view referenced by 23. The fourth camera system may be hidden and include at least one camera on a likewise hidden transfer device. The fifth camera system 15 may be positioned between a drive axle 5.6 and the attachment 2, such as on an underside of the agricultural work machine 1, and may be configured to detect the field of view referenced by 25.

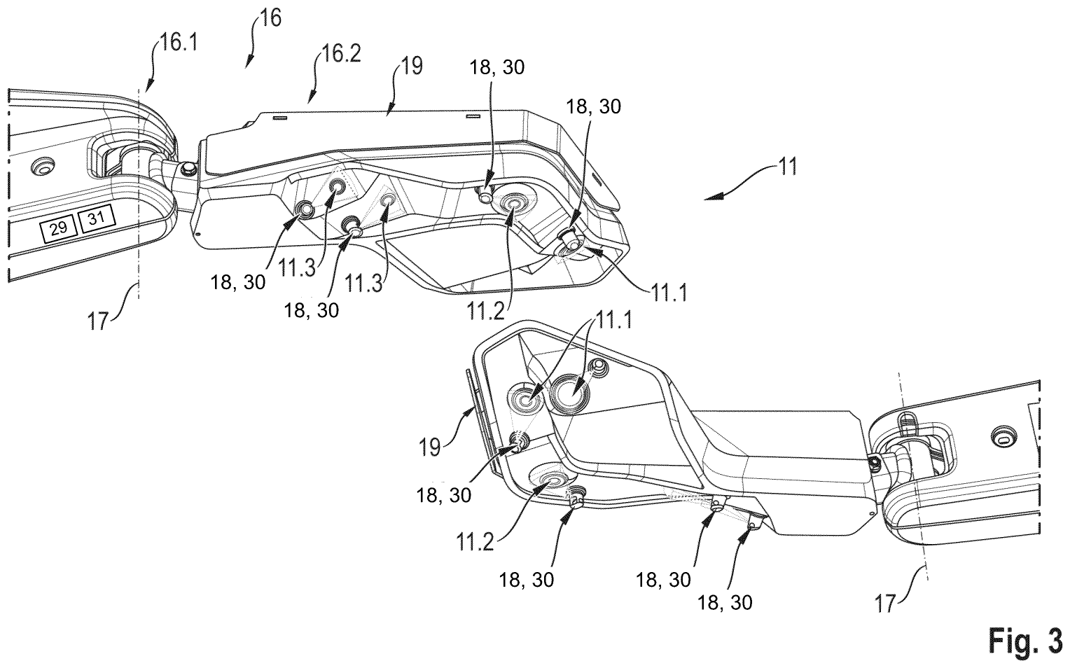

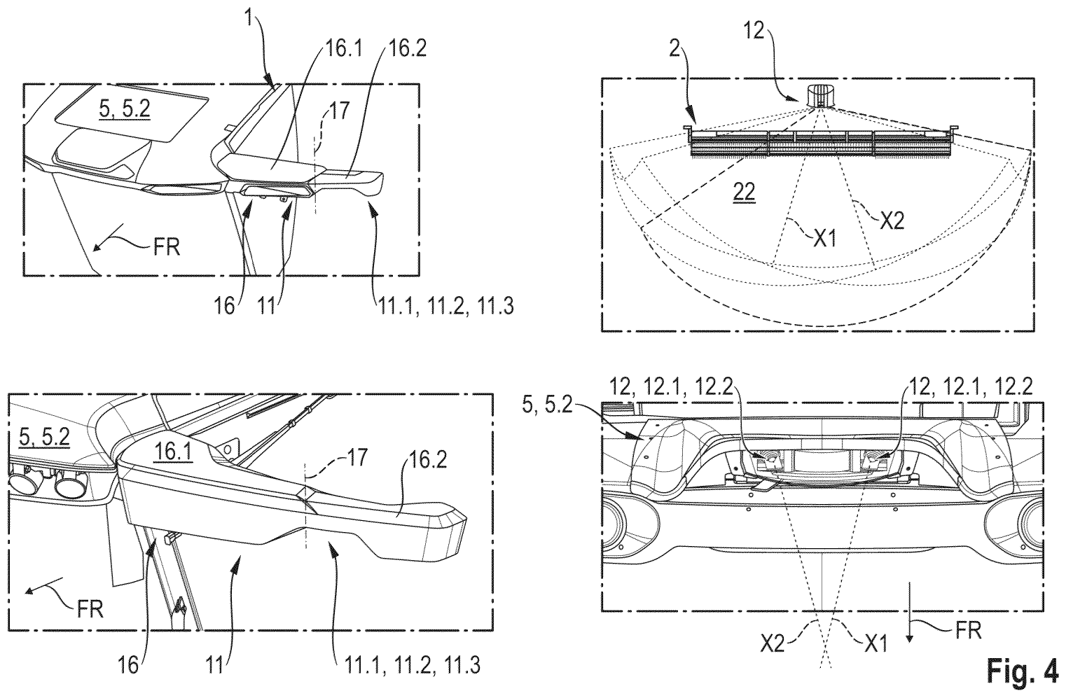

FIG. 3 illustrates an arm 16 in a perspective view, once from a front side (left in FIG. 3) and once from a rear side (right in FIG. 3). In one or some embodiments, the arm 3 may be configured to pivot about a substantially vertical pivot axis 17. The arm 16 may be configured to attach in or to an external mirror position of the agricultural work machine 1, wherein camera system 11, such as first camera system 11, of monitoring device 10 may be fixed (such as permanently fixed or temporarily or reversibly fixed) to the arm 16. The external mirror position may also be seen, for example, on the arms 16 shown in FIG. 2 and FIG. 4. The arm 16 may include a holding part 16.1 and a pivot part 16.2 for pivot-mounting the first camera system 11. The pivot part 16.2 may be fixed to the holding part 16.1 so that the pivot part 16.2 may be pivoted around the pivot axis 17 by a motor 29 (illustrated in FIG. 3). The pivot part 16.2 may be reset by motor 29, for example after pivot part 16.2 has been pivoted during a collision. The pivot part 16.2 may be protected against overload and may be pivoted relative to the holding part 16.1 in order to prevent damage in the event of a collision. Furthermore, a plurality of cleaning systems 18 may have one or more adjustable nozzles 30 positioned on the arm 16.

In one or some embodiments, the first camera system 11 and the cleaning systems 18 are installed in the pivot part 16.2. The pivot part 16.2 has a shield 19 in front in the direction of travel FR. The pivot part 16.2 may also form a shade against sunlight.

In one or some embodiments, the camera system 11 has plurality of cameras 11.1, 11.2, 11.3, such as precisely two first cameras 11.1, one second camera 11.2 and two third cameras 11.3.

The first cameras 11.1 may point substantially against a direction of travel FR to detect a field of view 21.1 located substantially to the rear of the agricultural work machine 1 in the direction of travel FR to generate the image data, see also FIG. 1, left.

The second camera 11.2 may substantially point to the ground for detecting a field of view 21.2 located in the proximity of the agricultural work machine 1 and/or containing a harvesting attachment 2 at least sectionally for generating image data and process data, see also FIG. 1, left.

The third cameras 11.3 may point substantially in the direction of travel FR and towards the ground to detect a field of view 21.3 located substantially at the front of a harvesting attachment 2 in the direction of travel FR and containing the harvesting attachment 2 at least sectionally for generating the process data, see also FIG. 1, left.

For each camera 11.3, 11.2, 11.3, a cleaning system 18 may be provided with a nozzle 30 for ejecting compressed air onto the particular camera 11.1, 11.2, 11.3. As discussed above, at least one processor 26, such as via the monitoring device 10 and/or the data processing unit 20, may generate command(s) and transmit the command(s) (using communication interface 28) in order to control the respective cleaning system 18. The inclinations of the nozzles may be adjustable by motor (see motor 29). A spray cone for the compressed air is indicated for each nozzle, which may be directed towards a particular optical opening or lens. In this regard, the at least one processor 26 may control the motor (to control the position or inclination of the respective nozzles) and/or may control valve 31 (which has a line connected to a tank of liquid or air) for ejecting the compressed air and/or liquid from the nozzles 30.

FIG. 4, top left and bottom left, illustrate an example of a cab roof 5.2 as support structure 5 of a work machine 1, on which cab roof 5.2 an arm 16 is fixed in an outside mirror position. An arm 16 arranged or positioned ‘on the left in the direction of travel FR is shown, wherein a similar arm 16 may also be provided on the right or opposite in the direction of travel FR.

A pivot part 16.2 of the arm 16 may be pivoted about a pivot axis 17 relative to a holding part 16.1, such as by a motor (e.g., via motor 29). In a collision or for maneuvering, the pivot part 16.2 may fold in, for example, by overcoming an overload protection (e.g., designed as a cam assembly, such as a spring-loaded cam assembly), acting between the pivot part 16.2 and holding part 16.1. The arm 16 may bear or support cameras 11.1, 11.2, 11.3 of a first camera system 11 of monitoring device 10 of the agricultural work machine 1 on the pivot part 16.2. The cameras 11.1, 11.2, 11.3 may be attached to each other in a fixed spatial arrangement and may provide a perspective for fields of view to be detected, based on which context-relevant process data and image data may be provided for a mirror replacement system. Thus, a work process may be quantified, and an improved overview may be created of what may be shown overall to a machine operator on displays.

FIG. 4, top right, illustrates the agricultural work machine 1 in the form of a combine harvester with a view of its harvesting attachment 2 substantially from the front (e.g., with a viewing direction substantially against the direction of travel). FIG. 4, bottom right, illustrates the agricultural work machine 1 in detail in the area of a cab roof 5.2 and with a view of a second camera system 12 of a monitoring device 10. Fields of view 22 of the second camera system 12, which may be integrated in a support structure 5 of the agricultural work machine 1, such as in the cab roof 5.2, are shown. The second camera system 12 may have a plurality of cameras, such as two cameras 12.1, 12.2, whose optical axes X1, X2 may cross in front of the two cameras 12.1, 12.2 in the direction of travel.

The optical axes X1, X2 intersect in the present case in a plan view of the agricultural work machine 1, such as with a viewing direction substantially orthogonal to the direction of travel FR, at a distance of within 5 m in front of the cameras 12.1, 12.2, such as within 2.5 m, or more particularly within 1 m.

Shown and described are agricultural work machines 1 that may be operated by means of a method for operation. In the method, the agricultural work machine 1 may perform a work process, and the camera system 11, 12, 13, 14, 15 or a plurality thereof detect fields of view 21, 22, 23, 24, 25. Context-relevant process data of the agricultural work machine 1 and image data of surroundings of the agricultural work machine 1 may be generated based on the detected fields of view 21, 22, 23, 24, 25. The process data and the image data may be displayed, for example, on a visualization unit 3 in the agricultural work machine 1.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Agricultural work machine
2 Harvesting attachment
3 Visualization device
5 Support structure
5.1 Vehicle cab
5.2 Cab roof
5.3 Exterior cover
5.4 Side flap
5.5 Transfer device
5.6 Drive axle
10 Monitoring device
11-15 Camera system
11.1 Camera
11.2 Camera
11.3 Camera
12.1 Camera
12.2 Camera
16 Arm
16.1 Holding part
16.2 Pivoting part
17 Pivot axis
18 Cleaning system
19 Shield
20 Data processing unit
21-25 Field of view
26 Processor
27 Memory
28 Communication interface
29 Motor
30 Nozzles
31 Valve
32 Touchscreen
FR Direction of travel
X1 Optical axis
X2 Optical axis

1. An agricultural work machine comprises:
a visualization device configured to display image data and context-relevant process data,
a monitoring device including one or more camera systems configured to detect one or more fields of view in a surroundings of the agricultural work machine, wherein each of the one or more camera systems has a respective camera, and wherein the respective cameras of the one or more camera systems have a fixed spatial assignment relative to one another;
one or more cleaning systems configured to clean the one or more camera systems; and
a data processing unit configured to generate, based on the detected one or more fields of view, the context-relevant process data of the agricultural work machine and the image data.

2. The agricultural work machine of claim 1, wherein the agricultural work machine comprises a combine harvester or forage harvester configured to perform a work process; and
wherein the data processing unit is configured to generate the context-relevant process data as numerical process data configured to quantitatively detect the work process performed.

3. The agricultural work machine of claim 1, wherein the data processing unit is configured to provide the image data for the visualization device as a mirror replacement system; and
wherein the image data for display on the visualization device comprises one or more of sections, compilations or perspective-corrected representations of the one or more fields of view.

4. The agricultural work machine of claim 3, wherein the visualization device comprises a respective display; and
wherein the data processing unit is configured to generate a respective compilation of a plurality of fields of view for display on the respective display.

5. The agricultural work machine of claim 3, wherein the visualization device comprises a plurality of displays; and
wherein the data processing unit is configured to generate a respective compilation of a plurality of fields of view for display across the plurality of displays.

6. The agricultural work machine of claim 1, wherein the data processing unit is configured to operate in at least a road operating mode and a work operating mode;
wherein, responsive to determining to operate in the road operating mode, the data processing unit is configured to generate the image data for display on the visualization device as a mirror replacement system.

7. The agricultural work machine of claim 6, wherein the data processing unit is configured to automatically determine to operate in the road operating mode; and
wherein, responsive to automatically determining to operate in the road operating mode, the data processing unit is configured to generate the image data for display on the visualization device as the mirror replacement system during an entire time in which it is determined to operate in the road operating mode.

8. The agricultural work machine of claim 1, wherein the data processing unit is configured to:
receive image data of a plurality of fields of view; and
output, via the visualization device, the image data of the plurality of fields of view.

9. The agricultural work machine of claim 8, wherein the data processing unit is configured to concatenate the image data from a plurality of cameras prior to output on the visualization device.

10. The agricultural work machine of claim 1, wherein the data processing unit is configured to:
responsive to determination as to one or more of a work process of the agricultural work machine, a user command, or a switch position:
perform one or both of selecting a subset of the image data for visualization or modifying the image data for visualization; and
perform one or both of selecting a subset of the process data for visualization or modifying the process data for visualization.

11. The agricultural work machine of claim 10, wherein the data processing unit is configured to:
determine the work process of the agricultural work machine being performed; and
responsive to determining the work process of the agricultural machine being performed:
perform both of selecting the subset of the image data and modifying the subset of the image data for visualization; and
select the subset of the process data for visualization.

12. The agricultural work machine of claim 1, further comprising an arm configured to attach on one end to an external portion of the agricultural work machine and at an opposite end to at least one camera of the one or more camera systems; and
wherein the at least one camera is positioned relative to a vehicle cab of the agricultural work machine as an external mirror for a machine operator in the vehicle cab.

13. The agricultural work machine of claim 12, the at least one camera is configured, via the arm, to pivot about a substantially vertical pivot axis.

14. The agricultural work machine of claim 13, wherein the arm includes a holding part and a pivoting part;
wherein the pivoting part is fixed to the holding part by a structure configured to protect against overloading; and
further comprising at least one motor configured to pivot the pivoting part about the substantially vertical pivot axis.

15. The agricultural work machine of claim 14, wherein the at least one camera is part of a first camera system;
wherein the one or more cleaning systems are at least partially installed in the pivoting part; and
wherein the pivoting part includes one or both of a shield mounted in front in a direction of travel of the agricultural work machine or a shade against sunlight for the first camera system.

16. The agricultural work machine of claim 1, wherein the one or more camera systems comprise at least one of:
a first camera positioned to point substantially against a direction of travel of the agricultural work machine in order to generate the image data for the field of view located substantially to a rear of the agricultural work machine in the direction of travel;
a second camera positioned to point substantially to ground in order to generate the image data for the field of view located proximate to one or both of the agricultural work machine or a harvesting attachment at least sectionally for generating one or both of the image data or the process data; or
a third camera positioned to point to one or both of substantially in the direction of travel or substantially towards the ground to detect the field of view located substantially at a front of the harvesting attachment in the direction of travel and contains at least a part of the harvesting attachment at least sectionally, for generating the process data.

17. The agricultural work machine of claim 1, wherein the one or more camera systems comprise each of:
a first camera positioned to point substantially against a direction of travel of the agricultural work machine in order to generate the image data for the field of view located substantially to a rear of the agricultural work machine in the direction of travel;
a second camera positioned to point substantially to ground in order to generate the image data for the field of view located proximate to one or both of the agricultural work machine or a harvesting attachment at least sectionally for generating one or both of the image data or the process data; and
a third camera positioned to point to one or both of substantially in the direction of travel or substantially towards the ground to detect the field of view located substantially at a front of the harvesting attachment in the direction of travel and contains at least a part of the harvesting attachment at least sectionally, for generating the process data.

18. The agricultural work machine of claim 1, wherein the one or more camera systems are positioned on or in a vehicle cab roof of the agricultural work machine and configured to detect a respective field of view for one or both of: located substantially at a front of a harvesting attachment of the agricultural work machine in a direction of travel; or containing the harvesting attachment at least sectionally;
wherein the one or more camera systems comprise two adjacent cameras whose optical axes cross along the direction of travel in front of the two adjacent cameras.

19. The agricultural work machine of claim 1, wherein the one or more cleaning systems include respective nozzles configured to eject one or both of compressed air or liquid onto at least a part of the one or more camera systems;
wherein the one or more camera systems include a plurality of cameras;
wherein each of the plurality of cameras includes the respective nozzle; and
wherein an inclination of the respective nozzles are adjustable.

20. A method for operating an agricultural work machine, the method comprising:
performing a work process using the agricultural work machine that includes:
a visualization device configured to display image data and context-relevant process data,
a monitoring device including one or more camera systems configured to detect one or more fields of view in a surroundings of the agricultural work machine, wherein each of the one or more camera systems has a respective camera, and wherein the respective cameras of the one or more camera systems have a fixed spatial assignment relative to one another;
one or more cleaning systems configured to clean the one or more camera systems; and
a data processing unit;
detecting, using the one or more camera systems, a plurality of fields of view;
generating, using the data processing unit and based on the plurality of fields of view that are detected, context-relevant process data of the agricultural work machine and image data of surroundings of the agricultural work machine; and
displaying the context-relevant process data and the image data.
